(19) United States
(12) Patent Application Publication
(10) Pub. No.: US 2017/0101923 A1
(43) Pub. Date: Apr. 13, 2017

(54) MULTIPLE PRECHAMBERS WITH INTERACTING JETS

(71) Applicant: Caterpillar Inc., Peoria, IL (US)

(72) Inventor: Andrew Loetz, West Lafayette, IN (US)

(73) Assignee: Caterpillar Inc., Peoria, IL (US)

(21) Appl. No.: 14/877,165

(22) Filed: Oct. 7, 2015

(51) Int. Cl. F02B 19/18; F02B 19/10; F02P 9/00; F02B 19/12

(52) U.S. Cl. CPC F02B 19/18; F02B 19/12; F02B 19/1095; F02P 9/002

(57) ABSTRACT

An internal combustion engine having a main combustion chamber, a first prechamber, a second prechamber, a first ignition plug and a second ignition plug. The main combustion chamber is in fluid communication with a first prechamber and a second prechamber. The first ignition plug is disposed in the first prechamber for igniting a charge in the first prechamber to form a first flame jet directed into the main combustion chamber. The second ignition plug disposed in the second prechamber for igniting a charge in the second prechamber to form a second flame jet directed into the main combustion chamber. The first flame jet and the second flame jet overlap in the main combustion chamber.

### TECHNICAL FIELD

The present disclosure relates to an internal combustion engine. In particular, the present disclosure relates to a pair of prechambers directing overlapping jets within the main combustion chamber.

### BACKGROUND

Internal combustion engines often emit harmful oxides of nitrogen (“NOₓ”) during operation. These oxides form when nitrogen and oxygen, both of which are present in the air used for combustion, combine within the main combustion chambers. Typically, the level of NOₓ formed increases as the peak combustion temperatures within the combustion chambers increase. As such, minimizing the peak combustion temperatures within the main combustion chambers generally reduces the emission of NOₓ.

For this reason, leaner fuel mixtures are used for reducing the peak combustion temperatures in the main combustion chamber, thus reducing the amount of harmful NOₓ emitted. A lean fuel mixture has a relatively large air-to-fuel ratio when compared to a stoichiometric air-to-fuel ratio. Accordingly, using more air in the fuel mixture may advantageously lower NOₓ emissions.

Further, most internal combustion engines use an ignition plug to ignite the fuel/air-fuel mixture periodically in the engine cycle. However, as the size of the combustion chamber increases, the effectiveness of ignition plugs to induce combustion is diminished. This is due in part because the arc generated by the ignition plug is very localized. The situation is exacerbated when the air/fuel ratio is made lean in an effort to reduce emissions and increase fuel efficiency. In a large combustion chamber, for example, it may take an undesirable period of time for the combustion process to propagate throughout the combustion chamber. Furthermore, using a lean air-to-fuel ratio may result in incomplete combustion i.e. lean misfire within the main combustion chamber. Moreover, turbulence within the main combustion chamber may extinguish the ignition flame before the lean air-fuel mixture combusts. Lean misfire in the engine causes reduced power output and an increase in the amount of un-combusted fuel. In some cases extinguishing of the ignition flame leads to the engine coming to a halt.

To minimize the occurrence of incomplete combustion, some internal combustion engines incorporate a pre-combustion chamber, or prechamber. Either enriched or non-enriched fuel may be advanced in these prechambers. Ignition of the fuel within the prechamber creates a jet of burning fuel that is directed into the main combustion chamber, thus igniting the lean air-fuel mixture within the main combustion chamber. However, the jet flame from the prechamber may not be sufficient to cause complete combustion of the lean air-fuel mixture within the main combustion chamber.

U.S. Pat. No. 3,924,582 discloses an internal combustion engine having a main combustion chamber and two symmetrically positioned auxiliary combustion chambers. Each auxiliary combustion chamber has a torch nozzle. The torch nozzles from the two auxiliary combustion chambers extend in opposite directions with respect to a plane containing the centers of the auxiliary combustion chambers.

### SUMMARY OF THE INVENTION

In one aspect of the present disclosure, an internal combustion engine having a main combustion chamber, a first prechamber, a second prechamber, a first ignition plug and a second ignition plug is disclosed. The main combustion chamber is in fluid communication with a first prechamber and a second prechamber. The first ignition plug is disposed in the first prechamber for igniting a charge in the first prechamber to form a first flame jet directed into the main combustion chamber. The second ignition plug disposed in the second prechamber for igniting a charge in the second prechamber to form a second flame jet directed into the main combustion chamber. The first flame jet and the second flame jet overlap in the main combustion chamber.

In another aspect of the present disclosure, a method of igniting a charge in an internal combustion engine comprising a main combustion chamber connected to a first prechamber and a second prechamber, a first ignition plug disposed in the first prechamber and a second ignition plug disposed in the second prechamber is disclosed. The method includes firing the first ignition plug to form a first flame jet followed by firing the second ignition plug to form a second flame jet. Further, directing the first flame jet and second flame jet into the main combustion chamber such that the first flame jet and second flame jet overlap in the main combustion chamber.

### BRIEF DESCRIPTION OF THE DRAWINGS

FIG. 1 illustrates a cross-sectional view of an internal combustion engine according to an embodiment of the present invention, in which an ignition plug is actuated.

FIG. 2 illustrates a cross-sectional view of an internal combustion engine in which another ignition plug is actuated.

FIG. 3 illustrates a cross-sectional view of an internal combustion engine wherein the flame jets overlap in the main combustion chamber.

FIG. 4 illustrates a cross sectional view of an internal combustion engine according to the another embodiment of the present invention.

FIG. 5 depicts a method of igniting charge within a prechamber and a main combustion chamber according to an embodiment of the present invention.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

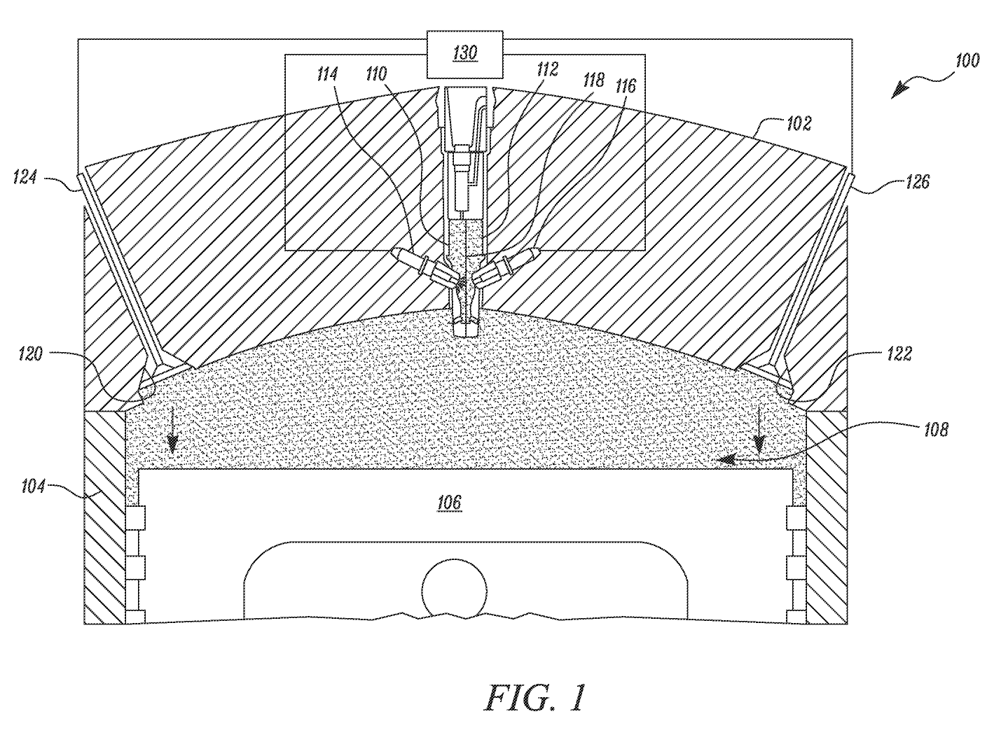

The present disclosure relates to an internal combustion engine for improving the combustion process and avoiding misfire. FIG. 1 illustrates an exemplary engine 100 configured to power a vehicle. In the exemplary embodiment, the engine 100 may be an internal combustion engine for a ground engaging machine. In various other embodiments, the engine 100 may be any engine running on solid, liquid or gaseous fuel, used for various purposes such as an automobile, a construction machine, any transportation vehicle and the like.

Referring to FIG. 1, a first embodiment of an internal combustion engine 100 includes a cylinder head 102 and a cylinder block 104. The cylinder head 102, the cylinder block 104 and a piston 106 form a main combustion chamber 108. The main combustion chamber 108 is configured to receive fuel/air-fuel mixture i.e. charge. The charge is burnt and the piston 106 is configured to transmit the driving force created by the burning charge to an output shaft (not shown).

The main combustion chamber 108 is in fluid communication with a first prechamber 110 and a second prechamber 112. The first prechamber 110 and the second prechamber 112 have a capacity that is smaller than that of the main combustion chamber 108. The first prechamber 110 and the second prechamber 112 are configured to receive either enriched or non-enriched charge. Ignition of the charge within the first prechamber 110 and the second prechamber 112 creates jets of burning charge that are directed into the main combustion chamber 108, thus igniting the lean charge within the main combustion chamber 108. In an embodiment, the first prechamber 110 and the second prechamber 112 may be of spherical shape to promote swirl inside the first prechamber 110 and the second prechamber 112. As one of skill in the art will appreciate, first prechamber 110 and the second prechamber 112 may be of any other type or shape known in the art. In the embodiment illustrated, the first prechamber 110 and the second prechamber 112 are disposed at substantially a central portion of the main combustion chamber 108 and are proximate to each other. In various other embodiments, the first prechamber 110 and the second prechamber 112 may be connected with the main combustion chamber 108 at other locations. In various other embodiments the engine 100 may have more than two prechambers.

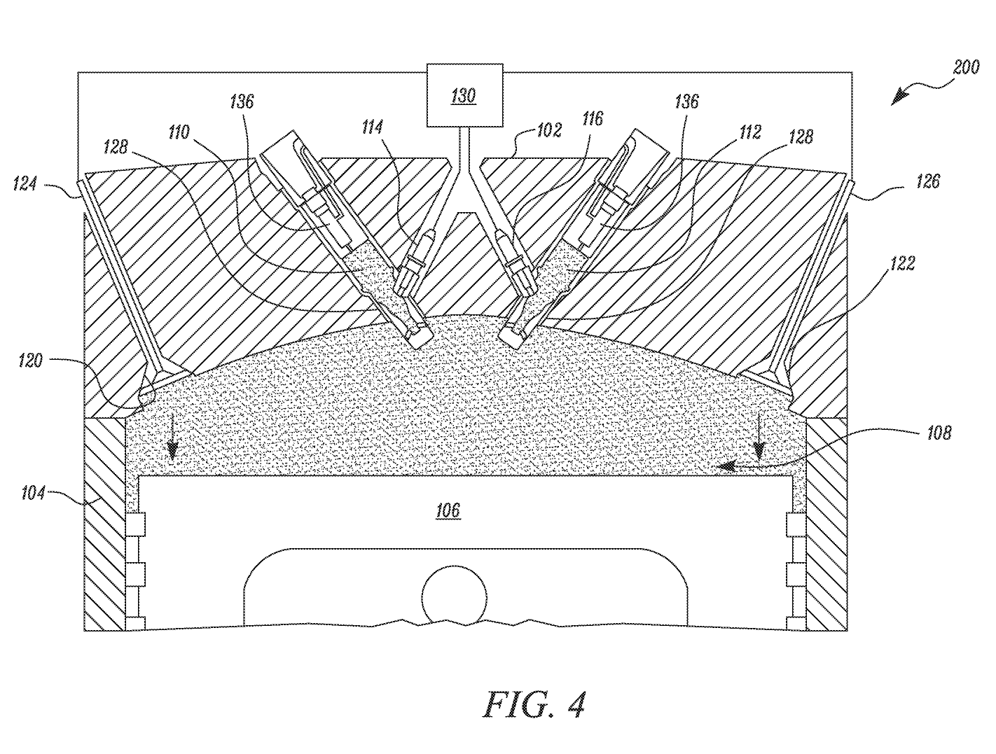

In the embodiment illustrated, the first prechamber 110 and the second prechamber 112 are formed from a main prechamber as shown in FIG.1. The main prechamber has a plate 118 that divides the main prechamber to form the first prechamber 110 and the second prechamber 112. In an alternate embodiment, the first prechamber 110 and the second prechamber 112 may be spaced apart from each other as shown in FIG. 4.

A first ignition plug 114 is disposed in the first prechamber 110. A second ignition plug 116 is disposed in the second prechamber 112. The first ignition plug 114 and the second ignition plug 116 may be connected with the first prechamber 110 and the second prechamber 112 by welding or other methods known in the art.

The first ignition plug 114 is disposed at the top of the first prechamber 110. The second ignition plug 116 is disposed at the top of the second prechamber 112. In an alternate embodiment, the first ignition plug 114 and the second ignition plug 116 are disposed at the end of the first prechamber 110 and the second prechamber 112 respectively, near the entrance to the main combustion chamber 108. In various other embodiments the first ignition plug 114 and the second ignition plug 116 may be disposed at other locations in the first prechamber 110 and the second prechamber 112 respectively. The first ignition plug 114 and the second ignition plug 116 may be typical J-gap spark plugs, rail plugs, extended electrodes, or laser plugs or any other type of spark plugs known in the art.

The cylinder head 102 includes an intake port 120 and an exhaust port 122. A charge intake valve 124 is disposed on the intake port 120. The charge intake valve 124 may be driven by an intake cam (not shown) to control the supply of the charge to the main combustion chamber 108. When the charge intake valve 124 is positioned in an open position the intake port 120 is in fluid communication with the main combustion chamber 108. Further, the charge intake valve 124 in the open position facilitates the introduction of charge through the intake port 120 and into the main combustion chamber 108. When the charge intake valve 124 is in a closed position, the intake port 120 is isolated from the main combustion chamber 108 thereby preventing charge from entering the main combustion chamber 108 via intake port 120.

An exhaust valve 126 may be disposed on the exhaust port 122. The exhaust valve 126 may be driven by an exhaust cam (not shown) to control the discharge of the combustion products from the main combustion chamber 108. When the exhaust valve 126 is in an open position, the exhaust port 122 is in fluid communication with the main combustion chamber 108. Further, the exhaust valve 126 in the open position allows the exhaust/combusted gases to advance from the main combustion chamber 108 and into the exhaust port 122. When the exhaust valve 126 is in a closed position the exhaust port 122 is isolated from the main combustion chamber 108 and prevents charge from exiting the main combustion chamber 108 and into the exhaust port 122.

The first prechamber 110 and the second prechamber 112 are in fluid communication with the main combustion chamber 108 through communication passages 128. The charge that is injected from the charge intake valve 124 is supplied to the main combustion chamber 108 as fresh charge, and is also supplied to the first prechamber 110 and the second prechamber 112 via the communication passages 128.

The engine 100 has an electronic control unit (ECU) 130. The electronic control unit ECU 130 may be a digital computer that may include a central processing unit (CPU), a read-only-memory (ROM), a random access memory (RAM), and an output interface. The ECU 130 receives input signals from various sensors (not illustrated) that represent various engine operating conditions. For example, an accelerator opening signal from an accelerator opening sensor may detect engine load, a water temperature signal from a water temperature sensor may detect engine temperature, and a crank angle signal from a crank angle sensor may detect the angular position of a crankshaft (not shown), and which may be used by the ECU 130 to calculate engine rotation speed (e.g., number of revolutions per minute of the engine 100). In response to the input signals, the ECU 130 controls various parameters that govern operation of the engine 100. For example, the ECU 130 may control the amount and timing of the charge injected by the charge intake valve 124, the ignition timing of the first ignition plug 114, and the ignition timing of the second ignition plug 116.

In accordance with a given operating condition of the engine 100, the ECU 130 controls a phase difference between the ignition timing of the first ignition plug 114 (i.e., ignition of the charge in the first prechamber 110) and the ignition timing of the second ignition plug 116 (i.e., ignition of the charge in the second prechamber 112). The ECU 130 controls the actuation of the first ignition plug 114 and the second ignition plug 116 such that the first ignition plug 114 is configured to ignite the charge in the first prechamber 110 prior to the ignition of the charge by the second ignition plug 116 in the second prechamber 112.

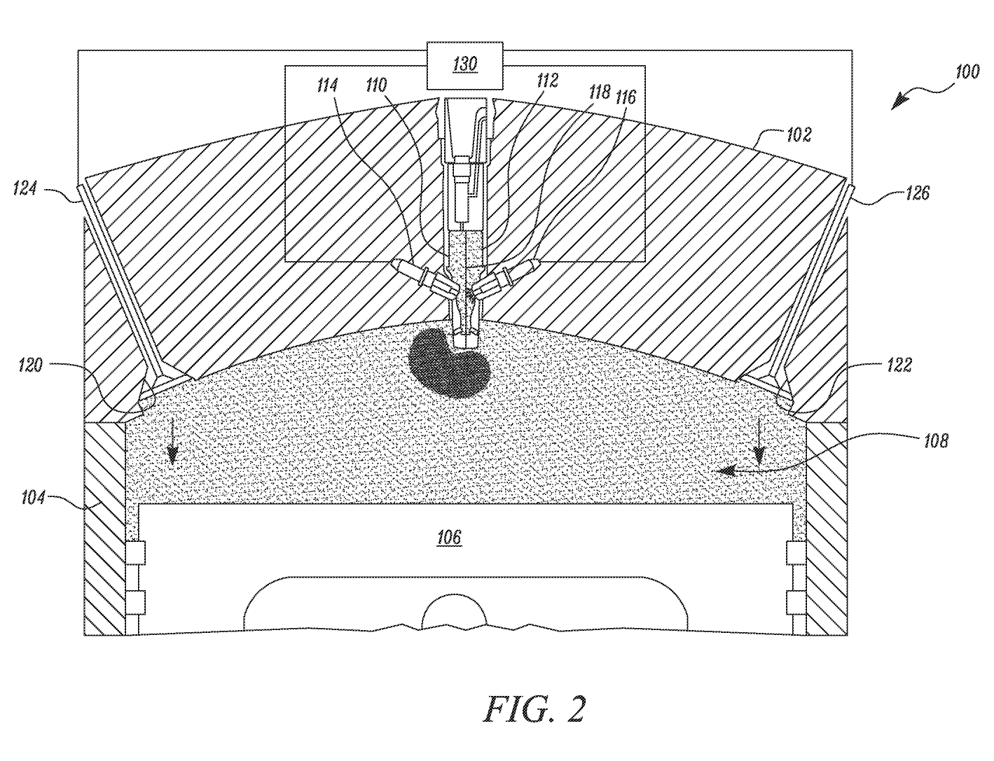

The working of the engine 100 along with the ECU 130 will now be explained in detail with reference to FIGS. 1-3. The ECU 130 generates an output signal that causes the charge intake valve 124 to open, thereby allowing enriched or non-enriched charge to advance into the main combustion chamber 108, the first prechamber 110 and the second prechamber 112. Referring to FIG. 1, once the charge advances into the main combustion chamber 108, the first prechamber 110 and the second prechamber 112, the ECU 130 generates an output signal that causes the first ignition plug 114 to create a spark in the first prechamber 110. The spark from the first ignition plug 114 ignites the charge within the first prechamber 110, which causes the flame jet i.e. a front of burning charge through the communication passage 128 and into the main combustion chamber 108 as shown in FIG. 2. The flame jet from the first prechamber 110 initiates combustion of the charge in the main combustion chamber 108.

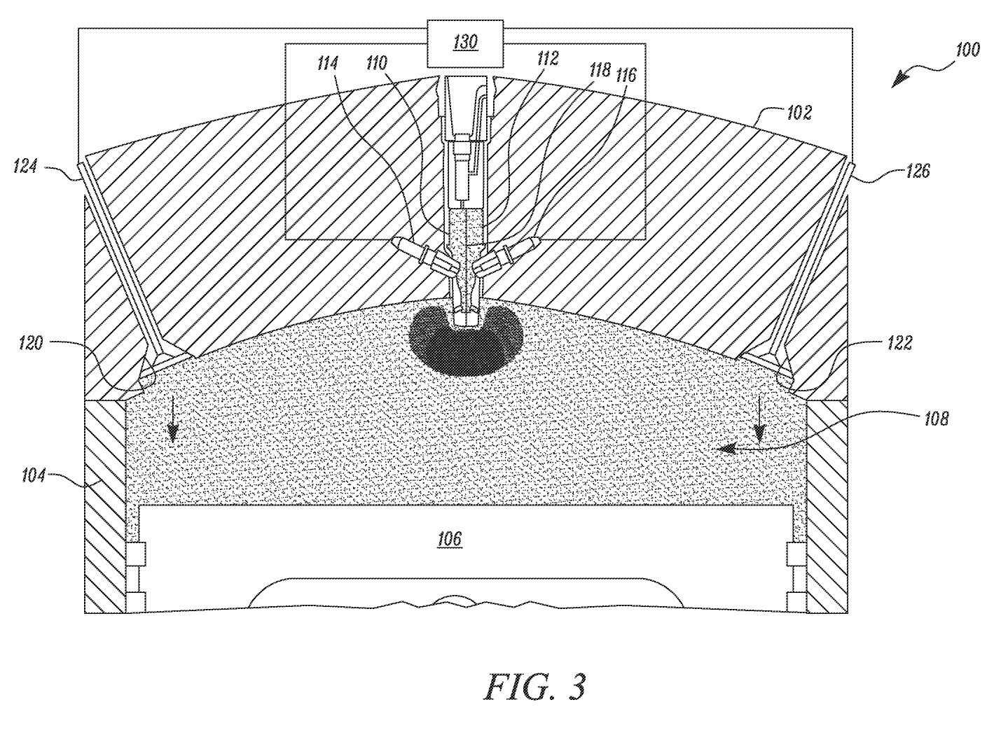

After actuating the first ignition plug 114, the ECU 130 fires the second ignition plug 116 causing an ignition of charge in the second prechamber 112 as shown in FIG. 2. The spark from the second ignition plug 116 ignites the charge within the second prechamber 112, which causes a flame jet from the second prechamber 112 to pass through the communication passage 128 and into the main combustion chamber 108 as shown in FIG. 3. The flame jets from the first prechamber 110 and the second prechamber 112 are directed into the main combustion chamber 108 such that the two flame jets from the first prechamber 110 and the second prechamber 112 overlap in the main combustion chamber 108 as shown in FIG. 3. The flame jet from the first prechamber 110 along with the flame jet from the second prechamber 112 facilitate complete combustion of the charge present in the main combustion chamber 108 during one cycle of operation of the engine.

In an embodiment the difference between firing of the first ignition plug 114 and the second ignition plug 116 may be 5-10 degrees rotation of the crankshaft. In other embodiments, the difference between the firing timings of the first ignition plug 114 and the second ignition plug 116 may be sufficient for the charge in the first prechamber 110 to be burnt by sparking of the first ignition plug 114. This burning of the charge directs the flame jet from the first prechamber 110 into the main combustion chamber 108 thereby heating a charge in the main combustion chamber 108 and providing a hotter mixture for the flame jet from the second prechamber 112 to ignite more robustly.

Now referring to FIG. 4, a portion of a second exemplary embodiment of internal combustion engine 200 is provided. In this embodiment, the engine 200 assembly is similar to the engine 100 assembly of FIG. 1. As such, many of the reference numerals used in FIG. 1 are also used in FIG. 4.

One difference between the embodiment of FIG. 4 and the embodiment of FIG. 1, is the presence of a prechamber intake valves 136 in the embodiment of FIG. 4. The prechamber intake valves 136 are disposed on both the first prechamber 110 and the second prechamber 112. The prechamber intake valves 136 are configured to allow charge to flow into the prechambers. In the embodiment illustrated, ECU 130 is electrically connected to the prechamber intake valve 136. The ECU 130 may control the amount and timing of the charge injected by the prechamber intake valve 136.

In the embodiment illustrated in FIG. 4, the ECU 130 generates an output signal that causes the charge intake valve 124 to open, thereby allowing enriched or non-enriched charge to advance into the main combustion chamber 108. Further, the ECU 130 may output control signals, to the two different prechamber intake valve 136 to open to introduce fresh charge in the first prechamber 110 and the second prechamber 112 respectively. Once the charge is advanced into the main combustion chamber 108, the first prechamber 110 and the second prechamber 112, the ECU 130 generates an output signal to actuate the first ignition plug 114 to create a spark in the first prechamber 110. Further, the ECU 130 generates an output signal to actuate the second ignition plug 116 to spark in the second prechamber 112 as described in the embodiment above.

### INDUSTRIAL APPLICABILITY

Power producing units such as diesel engines, gasoline engines, and gaseous fuel-powered engines require an optimum amount of fuel/air-fuel mixture to produce high power at a high efficiency. However, these engines often emit harmful oxides of nitrogen (“NOₓ”) during operation. These oxides form when nitrogen and oxygen, both of which are present in the air used for combustion, combine within the main combustion chambers. Since the level of NOₓ formed increases as the peak combustion temperatures within the combustion chambers increase leaner fuel mixtures are used for reducing the peak combustion temperatures in the main combustion chamber, thus reducing the amount of harmful NOₓ emitted. However, a leaner fuel mixture causes lean misfire inside the engine. This misfiring leads to reduced power output and an increase in the amount of un-combusted fuel. In order to maximize the power output generated by the combustion process in the engine and minimize the occurrence of incomplete combustion, some internal combustion engines incorporate a prechamber. Ignition of the fuel within the prechamber creates a jet of burning fuel that is directed into the main combustion chamber, thus igniting the lean air-fuel mixture within the main combustion chamber. However, the flame jet from prechamber may not be able to completely burn the charge present in the main combustion chamber.

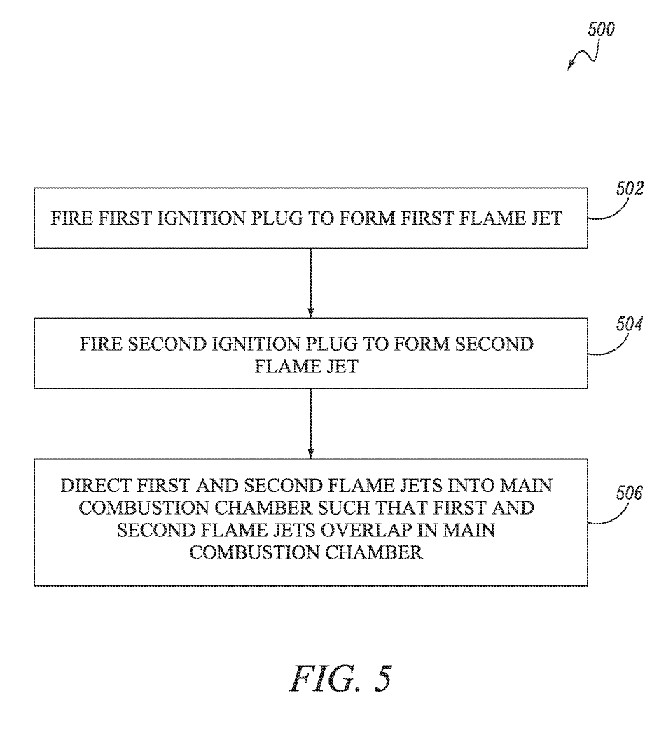

The method 500 of igniting the charge in the internal combustion engine 100 will now be described in detail with reference to FIG. 5. In an aspect of the present disclosure, a first ignition plug 114 and a second ignition plug 116 disposed on the first prechamber 110 and the second prechamber 112 are disclosed and shown in FIG. 1. The ECU 130 is configured to control the actuation timings of the first ignition plug 114 and the second ignition plug 116. The ECU 130 generates an output signal to the first ignition plug 114 to create a spark in the first prechamber 110 as shown in FIG. 1. The sparking of the first ignition plug 114 ignites the charge within the first prechamber 110, which causes a first flame jet i.e. a front of burning charge through the communication passage 128 and into the main combustion chamber 108 as shown in FIG. 2 (Step 502). This creates a high temperature region (shaded area) in the main combustion chamber 108 proximate the communication passage 128 of the first prechamber 110 as shown in FIG. 2. The high temperature area formed by the first flame jet from the first prechamber 110 initiates combustion of the charge in the main combustion chamber 108. This creates a hotter mixture of charge in the main combustion chamber 108 and enhances ignition of the charge in the main combustion chamber 108 using the flame jet from the second prechamber 112.

Further, as shown in FIG. 2, after actuating the first ignition plug 114, the ECU 130 generates an output signal to the second ignition plug 116 to create a spark in the second prechamber 112. This sparking of the second ignition plug 116 ignites the charge within the second prechamber 112 and creates a front of burning charge i.e. a second flame jet (Step 504). The second flame jet is then passed through the communication passage 128 and into the main combustion chamber 108 such that the flame jet from the second prechamber 112 overlaps the first flame jet from the first prechamber 110 in the main combustion chamber 108 (Step 506) as illustrated in FIG. 3. This creates an even higher temperature in the main combustion chamber 108 and allows for more robust burning of the charge within the main combustion chamber 108 thereby driving the piston 106 downward to produce mechanical output.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An internal combustion engine comprising:
a main combustion chamber in fluid communication with a first prechamber and a second prechamber;
a first ignition plug disposed in the first prechamber for igniting a charge in the first prechamber to form a first flame jet directed into the main combustion chamber;
a second ignition plug disposed in the second prechamber for igniting a charge in the second prechamber to form a second flame jet directed into the main combustion chamber;
wherein the first flame jet and the second flame jet overlap in the main combustion chamber.

2. The internal combustion engine of claim 1, wherein the first flame jet is directed into the main combustion chamber prior to the second flame jet.

3. The internal combustion engine of claim 1, wherein the first ignition plug ignites a charge in the first prechamber prior to the second ignition plug igniting a charge in the second prechamber.

4. The internal combustion engine of claim 1, wherein the first prechamber and the second prechamber are formed out of a main prechamber.

5. The internal combustion engine of claim 1, further comprising a plate in the main prechamber to form the first prechamber and the second prechamber

6. The internal combustion engine of claim 1, wherein the first prechamber and the second prechamber are centrally disposed with respect to the main combustion chamber.

7. The internal combustion engine of claim 1, wherein the first prechamber and the second prechamber are located proximate to each other.

8. The internal combustion engine of claim 1 further comprising an ECU configured to control operation of the first and second ignition plugs.

9. A method of igniting a charge in an internal combustion engine comprising a main combustion chamber connected to a first prechamber and a second prechamber, a first ignition plug disposed in the first prechamber and a second ignition plug disposed in the second prechamber; the method comprising:
firing the first ignition plug to form a first flame jet;
firing the second ignition plug to form a second flame jet; and
directing the first flame jet and second flame jet into the main combustion chamber such that the first flame jet and second flame jet overlap in the main combustion chamber.

10. The method of claim 9 comprising introducing a charge in the main combustion chamber, the first prechamber and the second prechamber, and compressing the charge during a compression stroke of the internal combustion engine prior to igniting the charge.

11. The method of claim 9 wherein the first flame jet from the first prechamber enters the main combustion chamber prior to the second flame jet from the second prechamber entering the main combustion chamber.

12. The method of claim 9 further comprising initiating combustion of charge in the main combustion chamber by the first flame jet to provide a hotter mixture for ignition by the second flame jet.
